(19) United States
(12) Patent Application Publication
(10) Pub. No.: US 2007/0250197 A1
(43) Pub. Date: Oct. 25, 2007

(54) METHOD AND APPARATUS FOR GENERATING MOSAIC FROM AN IMAGE

(75) Inventors: Boaz GLASS, Tel Aviv (IL); Gershon ELBER, Haifa (IL)

Correspondence Address: SOROKER-AGMON ADVOCATE AND PATENT ATTORNEYS, NOLTON HOUSE, 14 SHENKAR STREET, HERZELIYA PITUACH, 46725, omitted

(73) Assignee: Mosaic4U Ltd., Petach Tikva (IL)

(21) Appl. No.: 11/736,607

(22) Filed: Apr. 18, 2007

Related U.S. Application Data
(60) Provisional application No. 60/793,698, filed on Apr. 21, 2006.

(51) Int. Cl. G06F 19/00

(52) U.S. Cl. 700/96

(57) ABSTRACT

Methods and apparatus for generating mosaics from a given image. The method and apparatus comprise scanning the image into a computerized form, optionally marking guidelines on the image, and generating a mosaic description from the image. The mosaic description comprises tiles placed along the guidelines in directions tangent to the guidelines. A user can edit and make changes to the mosaic description. The mosaic description is optionally split to sheets, and transferred to a placing machine, preferably pick and place machine such as an SMT machine for generating a mosaic from the mosaic description.

### BACKGROUND OF THE INVENTION

1. Field of the Invention

The present invention relates to mosaic in general, and to a method and apparatus for constructing a mosaic from a given image, in particular.

2. Discussion of the Related Art

Mosaic is the art of decoration with small pieces of glass, ceramic, stone, wood, plastic, coconut shells or other material, having one or more colors and placed on a surface in an arrangement such as a design, a required image, a pattern, an abstract image, or any other tile combination. Mosaic may be used as decorative art, whether as part of interior or exterior decoration of a building or as a cultural or spiritual object, such as in cathedrals.

Generating a mosaic involves two stages, which may be performed together, but are usually preformed separately. First, the mosaic maker has to decide on the color and placement of the different tiles in the mosaic, in order to create the desired effect of the image, the pattern or the arrangement of the tiles. This stage may be performed by using traditional tools such as paper and pens, crayons or other drawing materials, or more advanced tools such as computer-aided drawing tools, executed on computers. However, both methods require high artistic capabilities from the mosaic maker. Additionally, the resulting design is not presented in a realistic manner to a user, due to the differences in color or pattern between the tiles as simulated by a computer and the actual tiles used. When using a computerized tool, it is not possible for the user to make slight changes to the resulting design, since changing the original picture and repeating the design generation process will not necessarily yield the expected result. The construction of the mosaic should also support dividing the resulting arrangement into a number of pages, wherein each page is of predetermined maximal dimensions, the dimensions derived from the equipment used for the second stage, of generating the mosaic or shipping the mosaic to the place where the sheets are attached to the destination, such as the wall, floor or others. Dividing the arrangement is further challenging if the tiles are not arranged in a grid.

The second stage is the tile placement stage, in which the tiles are placed on a surface according to the design. The surface may be the final destination of the mosaic, such as the wall or the floor of a building, or a temporary surface, such as an adhesive surface, a mesh or any other surface that enables the mosaic to be transported to its destination and placed there in the designated location. This step is labor-intensive and error-prone if carried out manually.

There is thus a need for a method and apparatus for receiving an image and providing a mosaic depicting the image.

### SUMMARY OF THE PRESENT INVENTION

The disclosed method and apparatus enable the construction of a mosaic from an image. In a preferred embodiment, the image is converted into an electronic form. A user then has the option of marking guidelines on the image, and a mosaic description is generated depicting the image. The user is then presented with a simulated mosaic, and is offered the option to edit the mosaic description by performing graphic operations. For realistic view, the mosaic is optionally presented using scanned images of tiles. In addition, the method and apparatus should enable the division of the simulated arrangement to separate sheets. The process provides to a user a simulated arrangement of tiles according to the image, the simulated arrangement being realistic as possible. The mosaic description is then transferred to a pick and place machine for placing the tiles on the surface in an automatic manner. A sophisticated and accurate pick and place machine is required. The machine should be able to place tiles of as many as possible colors, shapes, or patterns, so that one or at most few activations of the machine will suffice to place the tiles of a multi-color, multi-shape, or multi-pattern mosaic. This requirement is important when attempting to improve the time and hence the cost of preparing a mosaic. In addition, it is required that such a machine is reasonably priced and efficiently maintained. Yet another requirement is that the tiles are fed into the machine in an efficient and low cost process. The apparatus for placing the tiles according to the arrangement, and the process thereof is performed in a cost-effective manner.

There is thus provided in accordance with a preferred embodiment, an apparatus for generating a mosaic from a computerized file, the mosaic comprising a multiplicity of tiles placed on a surface, the apparatus comprising: a computing platform executing a process for generating a description of the mosaic from the computerized file; and a placing machine for placing the multiplicity of tiles on the surface according to the description of the mosaic, whereby the placement machine takes hold of the tiles, each tile taken from one of a set of predetermined locations and placing each tile in a location on a layer, as designated by the description of the mosaic. The apparatus can further comprise a process executed on the first computing platform or on a second computing platform, the process presenting the description of the mosaic and enabling a user to make changes to the description of the mosaic. Within the apparatus each tile is optionally placed on the location designated by the description of the mosaic by conveying the tile to the location designated by the description of the mosaic on the layer. The tile can alternatively be placed on the location designated by the description of the mosaic by conveying the tile to another predetermined location, and moving the layer so that the tile is above the location designated by the description. The tile can be moved vertically, i.e. along the Z axis towards the layer, or the layer can be moved vertically towards the tile. The placement machine can be a pick and place machine. The placement machine is optionally a surface mounting technology machine. The placement machine optionally comprises a vacuum mechanism for picking each of the multiplicity of tiles. The multiplicity of tiles can be introduced to the placement machine in a tube, on a tray, or on a strip, the strip optionally twisted around a reel.

Another aspect of the disclosed invention relates to a method for generating a description of a mosaic from a computerized file, the mosaic comprising a multiplicity of tiles placed on a surface, the method comprising: generating an initial description of the mosaic, the initial description comprising a location and color indication for each of the multiplicity of tiles; and graphically editing the initial description of the mosaic. The initial description of the mosaic optionally comprises also an orientation or a shape for each of the multiplicity of tiles. Optionally, graphically editing the initial description of the mosaic comprises simulating one or more actions from the group consisting of: moving one or more tiles, changing a color of one or more tiles, changing a pattern of one or more tiles, changing a shape of one or more tiles, rotating one or more tiles in a constant angle, rotating one or more tiles in a sequence of angles, removing one or more tiles, and adding one or more tiles.

Yet another aspect relates to a method for generating a description of a mosaic from a computerized file, the mosaic comprising a multiplicity of tiles placed on a surface, the method comprising: generating an initial description of the mosaic, the initial description comprising a location and color indication for each of the multiplicity of tiles making tip the mosaic; and presenting to a user a graphic representation of the description of the mosaic on a display device, wherein each tile is presented as a scanned image of a tile.

Yet another aspect relates to a method for generating a multi-page description of a mosaic from a computerized image, the mosaic comprising a multiplicity of tiles attached to a surface, the method comprising: generating a description of the mosaic, the initial description comprising a location and color indication for each of the multiplicity of tiles; and generating a division of the description of the mosaic into a multiplicity of pages along a multiplicity of lines. Within the method, one or more of the multiplicity of lines is optionally a curved line.

### BRIEF DESCRIPTION OF THE DRAWINGS

The present invention will be understood and appreciated more fully from the following detailed description taken in conjunction with the drawings in which:

FIG. 1 is a schematic illustration of a preferred embodiment of an apparatus for generating a mosaic from an image;

FIG. 2 is a schematic illustration showing the effect of marked lines on a mosaic description;

FIG. 3 is a flowchart of the main steps in a preferred embodiment of a process for generating a mosaic from a given image;

FIG. 4 is a flowchart of the main steps in a preferred embodiment of a process for generating a mosaic description from a given image;

FIG. 5 is a schematic illustration of a line marked by a user and an additional line determined by the system;

FIG. 6 is a schematic illustration of a preferred embodiment of a machine for generating a mosaic from a mosaic description; and

FIG. 7 is a flowchart of the main steps in wrapping and installing the mosaic.

### DETAILED DESCRIPTION OF THE PREFERRED EMBODIMENT

The present invention overcomes the disadvantages of the prior art by providing a novel method and apparatus for generating a mosaic from a given picture.

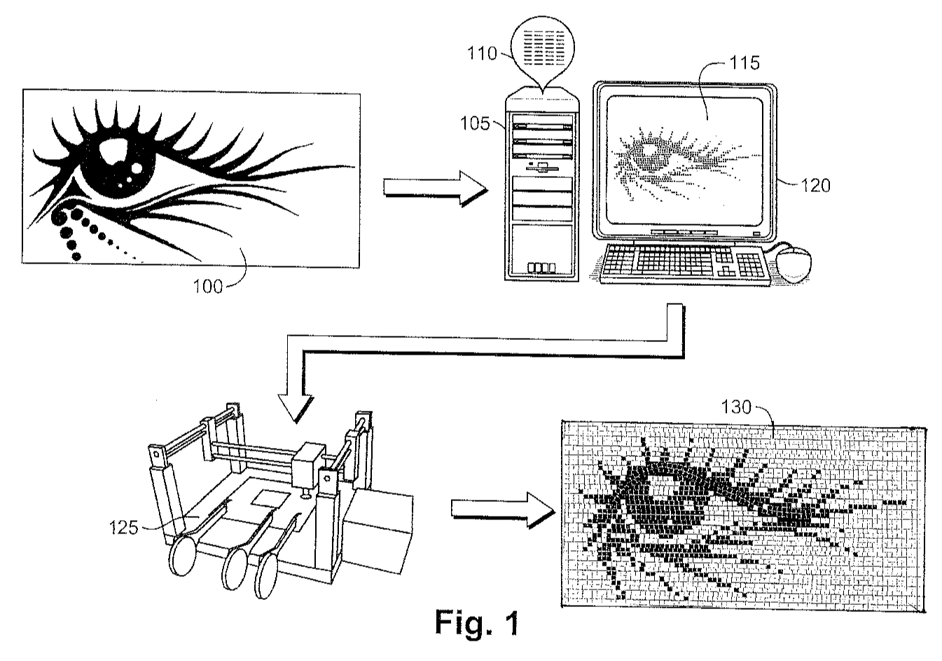

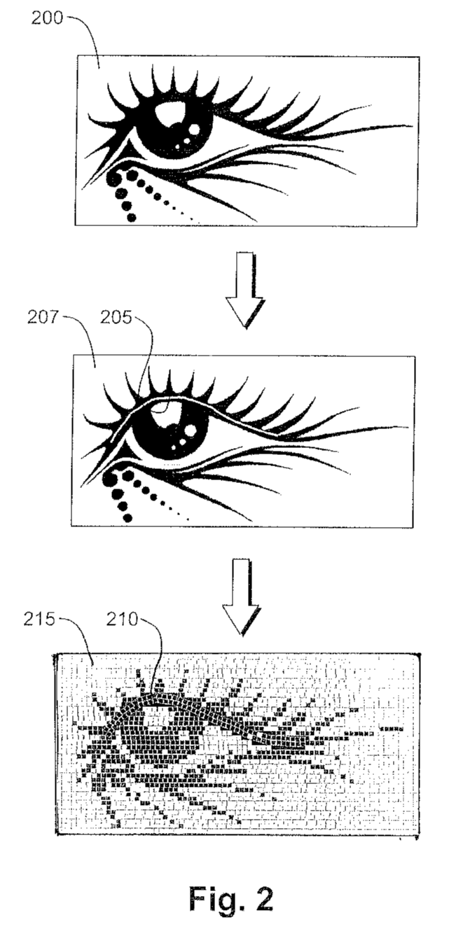

The method and apparatus as detailed in association with FIGS. 1 and 2 below include the step of converting the image or picture to a computerized file, preferably an image file. This can be done by any commercially available scanner, or by having the image available in an electronic format. Once the image is available in an electronic format, the image is presented to a user on a computerized display device. The user is then given the option to use an input device such as a pointing device to mark lines on the image, for example lines which enhance the outlines of features appearing in the image, or any other desired lines. The lines can include one or more straight or curved line segments.

Then, a mosaic description is generated from the image, wherein the lines marked by the user are covered by tiles adjacent to each other essentially along a full side of the tile, even when the line is not horizontal or vertical. Optionally, one or more lines of tiles are also arranged on any one or both sides of the marked lines. The tiles covering the rest of the image are preferably arranged in essentially straight lines, while taking into consideration the marked lines and their surroundings. Preferably, the colors of the mosaic are selected to match as realistically as possible the colors of the image with the colors of the stones available to the construction of the actual mosaic.

The mosaic description is then presented to the user. For a more realistic view, the presented tiles are not computer-generated shapes, but rather images of actual tiles, captured for example by scanning actual tiles into the computer and presenting the scanned images.

The user is then offered the option to graphically or textually edit the presented mosaic, by changing a tile to a tile of another color, moving, deleting, adding, rotating, or otherwise changing one or more tiles. Another offered feature is rotating of a group of tiles. When using this option, the user marks a group of tiles, and each tile is rotated along its middle. The rotation angle can be the same for all tiles in the group, or in a gradually changing angle (gradient), for purposes such as enhancing the visual continuity between tiles along a marked line and other tiles.

Once the user has finished editing the mosaic description, the description is transferred to a pick and place machine. Such machine can be a tailor-made machine for the purposes of generating a mosaic. Alternatively, commercially available pick and place machines often used in assembling electronic printed circuits can be used for the needs of tile mosaic assembly. The electronic assembly machines can be pick and place machines, for example Surface Mount Technology (SMT) machines, or they can use other technologies like through-hole. Such machines offer the option to use a variety ranging between about 10 and about 120 different components, or tile colors in the current usage. SMT machines provide high resolution, and can place elements oil any surface. The tiles can be supplied into the SMT machine using tubes, reels or trays, which can typically be cheaper than the equipment used for electronic components assembly due to the non-existing problem of static electricity, which does not affect a mosaic made of stone, glass or other non-conducting material.

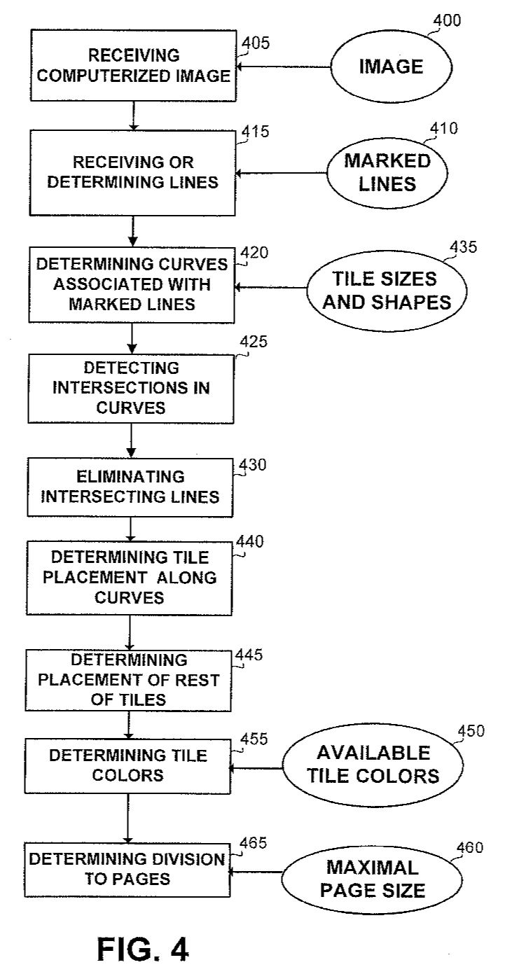

Referring now to FIG. 1, showing a schematic illustration of a preferred embodiment of an apparatus for generating a mosaic from an image. The process preferably starts with an image or a picture 100, according to which a mosaic is to be generated. Image or picture 100 is scanned into a computerized form by any scanner, resulting in a computerized file having any graphic format, such as Jpeg, Bitmap, GIF, or the like. In another preferred embodiment, the image was created in a computerized form or transferred earlier to a computerized form, so scanning is optionally skipped. Once the image is available in an electronic format, it is processed by a computing platform 105 executing an application 110. Computing platform 105 can be any general purpose processor, such as a personal computer, a laptop computer, a mainframe computer, or any other type of computing platform that is provisioned with a memory device (not shown), a CPU or microprocessor device, and several I/O ports (not shown). The processing performed by application 110 preferably comprises graphic human interface, so that a user can provide input relating to the image, while viewing the image or the mosaic description 115 on display device 120 the input optionally including guidelines within the image. The user can further view or enhance the resulting mosaic layout by performing graphic operations which simulate actions performed on tiles, such as moving, rotating, deleting, adding changing or the like. Application 110 can be programmed in any programming language, such as C, C#, C++, Java, VB, or others, and under any development environment, such as .NET, J2EE, or the like. Alternatively, the processing can be performed in firmware ported for a specific processor such as digital signal processor (DSP) or microcontrollers, or can be implemented as hardware or configurable hardware such as field programmable gate array (FPGA) or application specific integrated circuit (ASIC), adapted for processing images into the mosaic as detailed in association with FIG. 4 below.

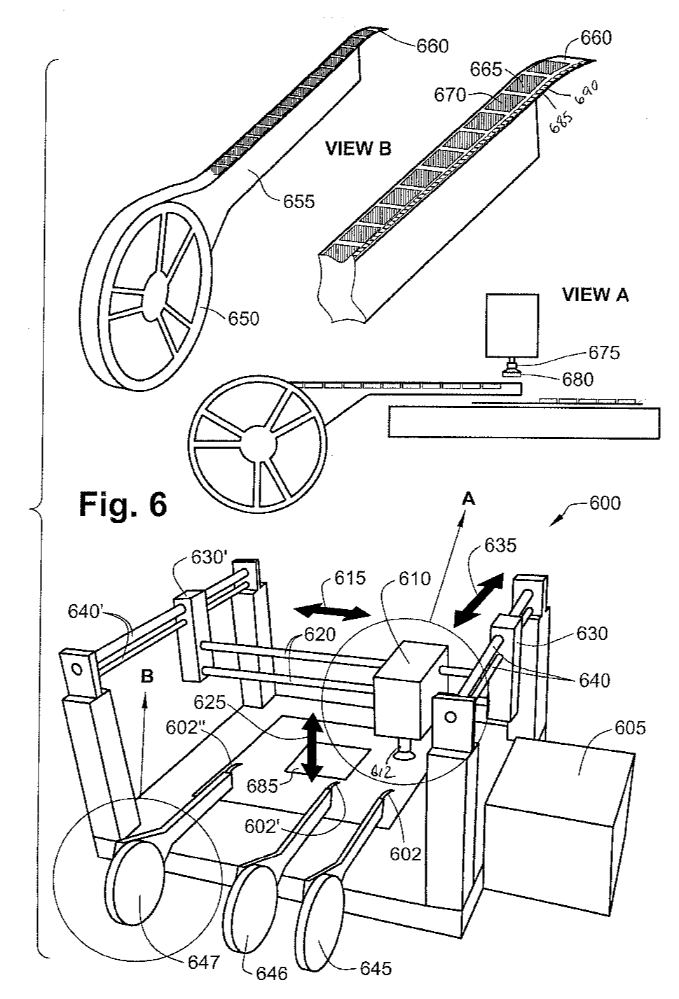

Once the execution result, being a mosaic description or a mosaic layout 115 is ready and acceptable by a user, it is transferred to a placing machine 125 for generating the mosaic. Machine 125 can be any robot, pick-and-place machine or other placement device which can receive a description of a mosaic, comprising a tile color, location and orientation, pick the tiles and place them accordingly. In a preferred embodiment of the disclosed apparatus, placement machine 125 is a Surface Mount Technology (SMT) machine. Machine 125, further detailed in association with FIG. 6 below, is generally used for placement of electronic components on printed circuits. SMT machines are appropriate for the task of placing tiles, due to their component supply or feeding options, picking mechanism which optionally uses a vacuum nipple or another mechanism appropriate for picking components having a smooth surface such as tiles, efficient algorithms for fast production and high resolution.

Referring now to FIG. 2, showing a schematic illustration showing the effect of marked lines on a mosaic. An optional step in mosaic designing relates to determining guidelines associated with the image. Such guidelines can be drawn anywhere on the image, and are usually used for enhancing features, delineating the foreground from the background or for other visual, artistic, or any other purpose. In the image shown in image 200, the user marked line 205, shown on image 207. When designing and later generating the mosaic, tiles 210 are placed along the marked line and not in the overall or default tile placement within the image, which is often horizontal-vertical grid-like placement as shown in mosaic 215. The tiles are preferably placed along the lines, oriented such that two of their sides are parallel and the other two are perpendicular to the tangent to the line at the area at which the tile is placed. Optionally, as shown in mosaic 215, multiple rows of tiles can be placed on either side of the row of tiles placed along the line, to make the guidelines appear more intense. Placing tiles along guidelines provides a more realistic view of the mosaic and is thus part of a preferred method of generating a mosaic from an image.

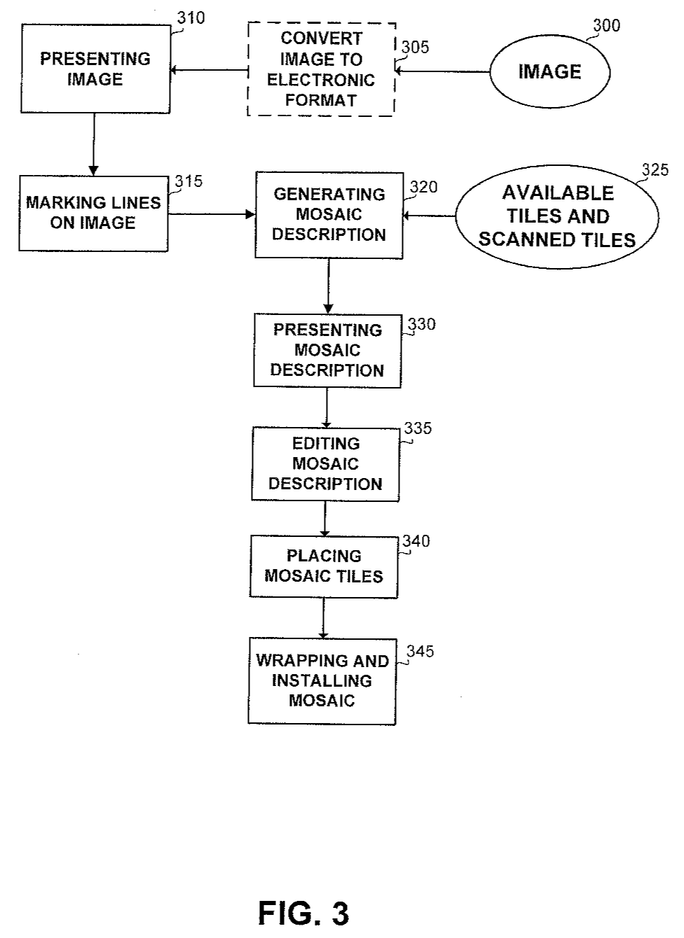

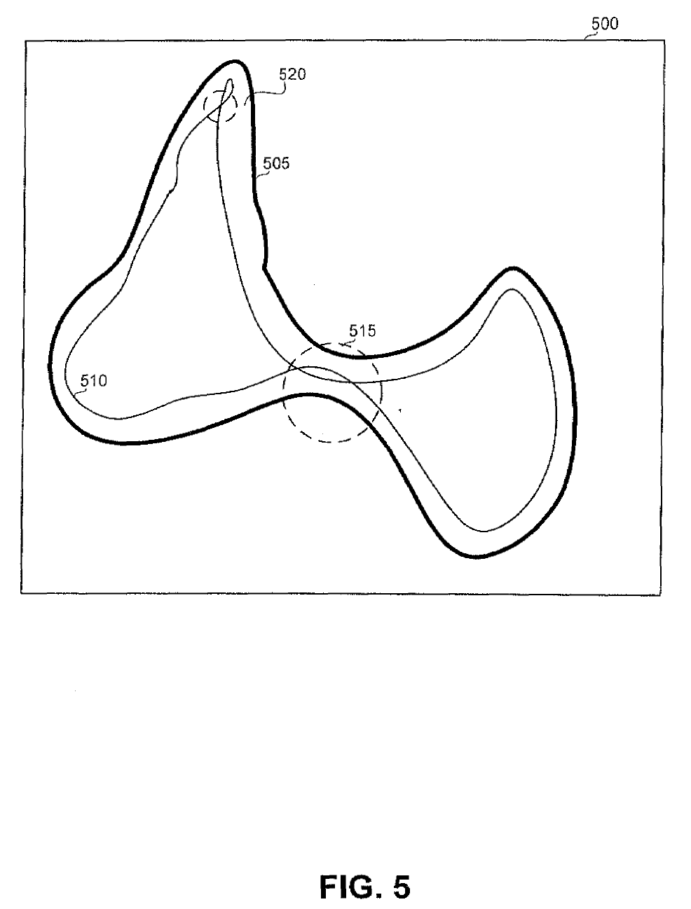

Referring now to FIG. 3 showing a flowchart of the main steps in a process for generating a mosaic from a given image. An image 300 is introduced to a computing platform on step 305, by converting to electronic format preferably by a scanner or a JPEG printer. There are no requirements for high scanning resolution, as the final mosaic resolution is typically quite low, typically between one and four tiles per square centimeter, so an image comprising a few hundreds to a few thousands pixels is sufficient. If the image is already available in an electronic format, step 305 can be skipped, and a file containing the image is transferred directly to step 310. On step 310 the image is presented to a user on a display device, such as a CRT, LCD or others. The image is presented by a process which also enables step 315 of marking lines on the presented image by the user. The lines can comprise straight segments, curved segments, free-hand segments or any combination thereof. A user typically marks lines enhancing features in the image, such as lines delineating the foreground of the image from the background of the image. Alternatively, image processing techniques, such as edge detection techniques could be used to suggest lines. When preparing the mosaic, tiles will be placed along these lines with their sides parallel and perpendicular to the tangent to the curve at the area at which they are placed, and not in other orientations, such as the normal grid-like placement. In addition, the user can indicate for each line or for each segment, how many rows of parallel tiles should be placed on either side of the marked lines. For example, if the user chooses a width of one row on either side of the marked line, the lines marked by the user will generally be presented on the mosaic by two parallel rows of tiles following the outline of the marked lines. In a preferred embodiment of the disclosed method, a line marked by the user is graphically prevented from intersecting itself or any other marked line. This is done by detecting if a point included in line is already included by that line or by other lines. The reason is that crossing of two rows of tiles can look visually awkward and are thus generally undesirable. The problem of intersecting lines is further detailed in association with steps 425 and 430 of FIG. 4 below. The coordinates of the lines and the selected widths of either side of the lines are stored, and the computerized image and the lines are transferred to step 320. Further input to step 320 is a description of the available tiles and scanned images thereof 325. The description of the available tiles comprises their sizes, and a description of their reference color. The tiles are optionally not uniformly colored, so their reference color is either the color of a point on the tile, the average color of the tile, or any other function of one or more colors appearing on the tile. The color is can be supplied in any coloring scheme such as the Red-Green-Blue (RGB) coding. On step 320, a description of the mosaic is generated, as detailed in association with FIG. 4 below. The description includes a list of records, each record comprising a tile indicator comprising the tile color and shape, a location for the tile, preferably in X, Y coordinates from a reference point, such as the coordinates of the tile of the first record, and a rotation angle Theta, indicating how much the tile should be rotated relatively to its base position. The base position is usually defined such that the tiles' canonical orientation, e.g. two sides in the case of square tiles, is parallel to the sides of the image. On step 330 the mosaic description as generated on step 325 is presented to the user. Preferably, for a realistic view of the mosaic, instead of displaying each tile as a computer-generated uniformly-colored tile, a scanned image of the relevant tile is shown. In a further preferred alternative, a number such as 3, 10 or any other number of scanned tiles of each color are available, and a randomly selected scanned image of the relevant tile is presented. On step 340 the user can graphically edit the resulting mosaic description. The editing options include, among others, simulating one or more of the following actions performed on the mosaic: deleting one or more tiles, changing the color of a tile to another available color, moving one or more tiles, placing an additional tile if enough free space is available, and other graphic options. Additional option is the rotation of one or more tiles. The user can group together a number of files and rotate them together. Each tile belonging to the group may be rotated around its middle point (for example the crossing point of its diagonals) in the same angle, or along a gradient. For example, is the group consists of a row of ten tiles, the tile having the lowest X value within the group is rotated in an angle of Z degrees, the tile to its right, having higher X value is rotated in 0.9Z degrees, and so on, until the last tile is rotated in 0.1Z degrees. This provides a smooth transition between tiles having certain angles, such as tiles placed along a line marked by the user on step 315 and other areas of the image. Once the user has finished editing the mosaic, the enhanced mosaic description is passed to the pick and place machine which places the mosaic tiles on step 340. A further input to step 340 is the actual tiles which are fed to the pick and place machine. A preferred embodiment of the pick and place machine is detailed in association with FIG. 5 below. Once the tiles are placed on a layer, the mosaic is preferably wrapped, shipped and then installed in its destined location. The wrapping and installation are further detailed in association with FIG. 6 below.

Referring now to FIGS. 4 and 5; FIG. 4 showing a flowchart of the main steps in a preferred embodiment of a method for generating a mosaic description from a given image. The method is further detailed in Rendering Traditional Mosaics by Elber et al., published in The Visual Composer (2003) 19:67-78. For clarity purposes, the main steps of the method are detailed hereinafter. The method is preferably performed by a set of computer instructions performed by a computing platform, as detailed in association with FIG. 1 above. Thus, the system mentioned below is preferably a computer software performing the method. On step 405 computerized image 400 is received by the system. On step 415 the system either receives the coordinates of lines 410 marked by the user on step 315 of FIG. 3, or determines such lines using image-processing techniques. The lines are preferably extracted as edges that delineate the foreground of the image from the background. On step 420 the system determines the curves associated with the marked or determined lines. The required number of curves is determined using the desired number of rows on either side of the marked line, as denoted by the user. The distance between the lines is derived from the provided tile sizes and shapes 435, and possible additional factors such as the typical gap desired between two adjacent tiles, which is preferably filled by grout at installation. If no width was denoted by a user, then only one curve is determined. On step 425 intersections are detected in the marked or the determined curves. Although intersections in the lines marked by the user are preferably prevented as detailed in association with step 315 of FIG. 3 above, such intersections can still present themselves in the additional lines, as can be seen in FIG. 5. FIG. 5 shows an image 500. For clarity, no features are shown on the image. Thick line 505 is marked by a user at step 315 of FIG. 3, preferably as a feature enhancing line, and tiles are to be placed along line 515 having their sides parallel and perpendicular to the tangent of the line at every point at which a tile is placed. If the user indicated that one or more parallel rows of tiles should be placed on the interior of line 505, thin line 510 denotes the general shape of such line, along which tiles should be placed in parallel to the tiles placed along line 505. It can be seen that line 510 intersects itself twice, in two different forms: a double, or global self intersection as indicated in area 515 and a single, or local self intersection as indicated in area 520. Such intersections are undesirable since tiles can not be placed so the continuity of both sides of the intersections is kept. Thus, these intersections are eliminated in step 430. The elimination can be performed by trimming the intersecting segments. The trimmed away segments are determined by either examining the local curvature of the curve for detecting local self intersections, by minimal distance testing for detecting global self intersections, or by solving for the self intersection points or areas of the curve. Once the lines are determined, the tile placement along the lines is determined on step 440. The tiles are placed so that their canonical orientation is parallel or perpendicular to the tangent of the respective curve. For example, square tiles are preferably placed with two of their sides parallel and the other two perpendicular to the tangent of the curve. The tiles are placed as close to one another as possible, while taking into account a limitation of minimal distance between tiles, if such limitation was introduced. On step 445 the location of tiles is determined for the rest of the image, i.e. those areas of the image not covered by the lines marked by the user and the lines parallel thereto. In a preferred embodiment, placing the rest of the tiles can be performed row-wise, while in each row the tiles are placed starting from a marked line and outwards, or in any other order. The row-wise placement can be further augmented with a “shaking” procedure applied at one or more tiles, for evening or reducing gaps between tiles, possibly near the outlined curves. The “shaking” optionally uses optimization techniques such as simulated annealing. Steps 420, 425, 430, 440, 445 can be replaced with a more naïve algorithm, of placing the tiles along the lines as packed together as possible while ignoring intersections, and finally filling the rest of the tiles. Alternatively, the lines can be ignored altogether and the locations of the tiles can be arranged in a grid that covers the image. However, the presented algorithm, provides a more realistic result. Once the placement of all tiles is determined, the available tile colors 445 are presented to the system, and on step 450 the colors of the tiles are determined. For each available color, its typical RGB representation is determined. Then, the system determines the color appearing in the image at the pixel closest to the middle point on which each tile is to be placed, such as the crossing point of the diagonals of the tile location. The system then determines from all available tile colors the tile color that is closest to the color of the pixel, and associates the tile color with the respective tile location. The color similarity can be chosen according to least square differences method or the like. In another preferred embodiment, the system can determine the average color of the pixels to be covered by the same tile, and selects the tile color that is most similar to the average color. On step 465, given the maximal sheet size 460 upon which tiles can be placed using the available equipment, the system determines the division of the image to pages. Once the division is determined the sheets can be separately manufactured and assembled together during installation. The division can be performed by drawing vertical and horizontal lines which form areas that are smaller in at least the size of a tile diagonal in any dimension than the maximal sheet size. For example, if the maximal sheet size is 50 cm×50 cm, and a tile size is 1 cm×1 cm, then lines can be drawn at about maximum 48.5 cm apart. Then, it is determined for tiles that are intersected by the lines, over which sheet the middle point of the tile resides, and the tile is associated with that sheet. Once step 465 is performed, the mosaic is described as a list of sheets, each sheet comprising a collection of tiles, each tile having a serial number, a color indication associated with a specific available tile color, a location preferably expressed in X and Y coordinates, and a rotation angle.

Referring now to FIG. 6, showing a schematic illustration of a machine for generating a mosaic from a mosaic description determined by the method presented in FIG. 4, or by any other method. The machine is preferably an SMT pick and place machine, often used for placing electronic components. The machine receives input related to placing the tiles. The input is preferably in a table, a tab-delimited text file, a spreadsheet or any other format which preferably designates for each tile a tile type or color, a location expressed in X and Y coordinates, and a rotation angle. The description can further comprise additional fields or data.

The placing machine, generally referenced 600, collects tiles from a set of predetermined locations 602, 602′, or 602″ and places each one of the tiles in a required location and orientation on layer or surface 685. In a preferred embodiment, each tile type is collected from one or more predetermined locations, i.e. generally multiple tiles of each type are collected from one location, but two or more locations can supply tiles of the same type, for example when there is a dominant tile type in the mosaic. The machine comprises a placement head 612 attached to a manipulator 610. Placement head 612, further detailed in view A, comprises one or more holding elements such as holding element 680. Preferably, holding element 680 is coupled to cylindrical element 675. Holding element 680 can be, for example, a vacuum nipple or another mechanism for lifting and transferring tiles. Manipulator 610 can move in the X and Y directions, and holding element 680 can further move in the z direction. Movement in the X direction as shown by arrow 615 is enabled by manipulator 610 sliding along rails 620. Movement in the Y direction as shown by arrow 635 is enabled by manipulator 610, rails 620, carriages 630 and 630′ sliding along rails 640 and 640′ respectively. Movement in the Z direction as shown by arrow 625 is enabled by cylindrical element 675 connected to sliding up into manipulator 610 and down. Cylindrical element 675 can further rotate around itself, and thus rotate holding element 680 and the held tile, for placing the tile in any required orientation. The movements of manipulator 610 and holding element 680 are controlled by control unit 605 which is controlled by a processor (not shown) such as a general purpose processor, a field programmable gate array (FPGA), or an application specific integrated circuit (ASIC), adapted for planning the movements of holding element 680. Holding element 680 is thus manipulated to take hold, pick, or grab a tile from one of predetermined locations 602, 602′ and 602″, lift the tile to a predetermined height, convey the tile by moving manipulator 610 in the X and Y direction, and then lower the tile and place the tile on the required location on layer 685. Holding element 680 optionally rotates prior to lowering the tiles to place the tile in the required orientation. In another preferred embodiment, each tile is picked from one of the predetermined locations, but is conveyed to a fixed location. Layer 685 then moves horizontally, i.e. along the X and Y axes so that the tile is above the required location, and the tile is then moved vertically, i.e. along the Z axis towards layer 685. Alternatively, layer 685 moves vertically, i.e. along the z axis towards the tile, as well as horizontally, i.e. along the X and Y axes, and then optionally moves back along one or more of the axes.

The order of the tile placement is determined by the specific machine used. A machine can be designed to place all components (tiles in the current context) of a certain type (color) before switching to components (tiles) of a different type (color). Alternatively, a machine can be designed to place the tiles row-wise, or to always attempt to place the tile closest to the last placed tile, or any other placing strategy.

In a preferred embodiment each tile comprises a smooth side and a slotted side, wherein the smooth side is the external side of the installed mosaic, and the slotted side faces the wall, floor or another surface on which the mosaic is attached to. In a preferred embodiment of the apparatus and method, the tiles are fed to the machine with their smooth side up, so a vacuum nipple or another mechanism can be used as grabbing element 680 for lifting a tile. The slotted side of the tile is thus placed on layer 685. In accordance with one exemplary embodiment, layer 685 is typically sized between 10 cm×10 cm and 1 m×1 m. Layer 685 is adhesive, so that the tiles will remain attached to the layer during wrapping and transportation to the installation site. Alternatively, layer or surface 685 can be a mesh designed to hold the slotted side of the tiles. In yet another alternative, the smooth side of the tiles can be attached to layer 685, if a lifting mechanism such as a gripping mechanism or a vacuum mechanism with a nipple shaped to be attached to the surface of the tiles is used to lift the tiles. Layer or surface 685 is placed and calibrated with machine 600, preferably using fiducials or other calibration devices placed at known locations and attached to layer 685. The tiles can be introduced to machine 600 in a variety of ways. A preferred embodiment shown in FIG. 6 comprises reels 645, 646, 747, further detailed in view B. Each reel comprises a spinning part 650 and a feeder 655. Spinning part 650 is placed on feeder 655, which connects spinning part 650 and the tape or strip 660 wrapped or twisted around spinning part 650 to the machine. The feeder is specific to the used machine, and designed to be used with a predetermined tape width. The feeders are changeable according to the job performed. Spinning part 65 and strip 660 preferably arrive pre-packaged with the tiles and may be disposable. The tiles such as 667 and 670 are placed on a strip 660 twisted around the reel and comprising sockets for the tiles. Tape or strip 660 is preferably made of a flexible material, such as a thin layer of plastic, and comprises recesses therein, each recess having size and shape designed for receiving one tile placed therein. The recesses are preferably sized and shaped to contain a tile. All tiles placed on a strip are preferably of the same or similar type, shape, and color or design. The tiles are preferably covered by a flexible thin layer, such as plastic, nylon, or the like, to keep the tiles from falling out of the recesses. The tiles are preferably placed with their slotted surface facing strip 660. Unlike electronic components, tiles are not sensitive to static electricity, so there are no conductivity limitations on the materials of which strip 660 can be made, and the strip manufacturing costs can be reduced. Strip 660 preferably carries perforations 685, 690 on one or both sides. Preferably, the side of a tile 665, plus the distance between two adjacent tiles 665, 670 is a multiple of the perforation distance of the strip, i.e. the distance between two adjacent perforation holes 685, 690, so that the strip is advanced a predetermined number of perforation holes after supplying each tile.

In an alternative embodiment, the tiles are supplied to the machine in generally diagonally positioned tubes, typically positioned at between 10 and 60 degrees, and preferably at about 30 degrees which are vibrated, either constantly or after the delivery of each tile, so that the next tile slides down.

In an alternative embodiment, the tiles are supplied to the machine in matrix-like tray or another container wherein the pick location changes after the picking of each tile, until the tray is empty.

It will be appreciated that a pick and place machine according to the description is not limited to picking and placing tiles of a single size and shape, and if a mosaic description comprises tiles of different shapes and sizes, then such tiles can be used by the machine.

In both embodiments, the holding element collects the tiles from a set of predetermined locations, each location is associated with a certain tile type or color during setup of the machine.

The number of tile sizes, shapes, and colors that can be used depends by the number of reels which can be used simultaneously by the machine, and typically varies between about 60 and about 120. If a mosaic is designed to contain tiles in more colors than the number of reels which can be used by the machine, it is possible to activate the machine with the enabled number of colors and the description relating only to tiles of these colors, and then reactivate the machine one or more times with the tiles and description relevant for additional colors.

In preferred embodiments, machines of L Series System APS manufactured by APS Inc. of Huntingdon Valley, Pa., U.S.A. (www.apsgold.com), manufactured by Essemtec AG, of Aesch, Switzerland (www.essemtec.com), BS383 manufactured by Autotronik of Amberg, Germany (www.autotronik-smt.de), A-Series machines manufactured by Assembleon of La Veldhoven, The Netherlands (www.assembleon.com), or others can be used for assembling mosaic according to the disclosed methods. Once the tiles have been placed by the machine shown in FIG. 6 or another machine, according to the description provided by the method of FIG. 4 or another method, each sheet of the mosaic, comprising an adhesive layer carrying the tiles, has to be wrapped in a manner that will facilitate installation of the mosaic in its designated location, and later installed at the destination.

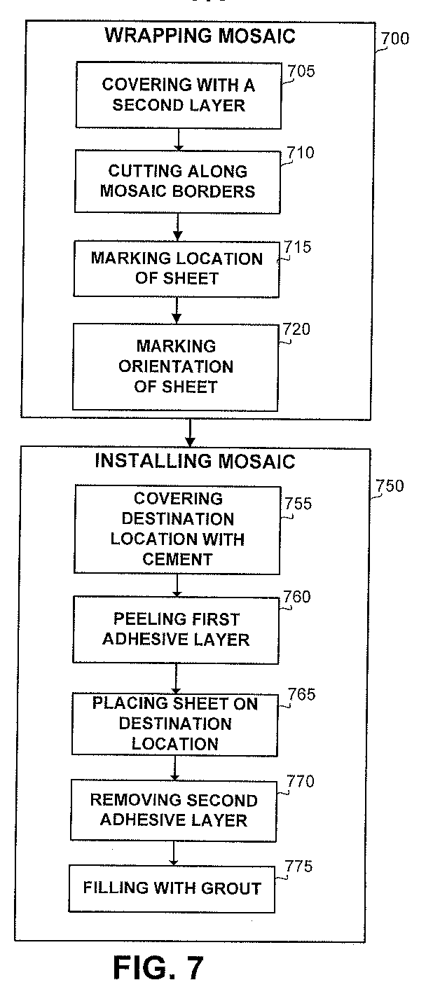

FIG. 7 is a flowchart showing the main steps in wrapping the mosaic, generally referred to as 700, and in installing the mosaic, generally referenced 750. Preferably, the tiles have been placed so that the back side of each tile is in touch with the adhesive layer, hereinafter referred to as the first adhesive layer or the back adhesive layer. On step 705 the tiles are covered by a second adhesive layer, or a front adhesive layer which is pressed to the tiles, so that the front face of the tile is substantially in contact with the front adhesive layer. Preferably, the front adhesive layer is more adhesive than the back adhesive layer, i.e. comprises stronger glue or a larger amount of glue than the first adhesive layer. On optional step 710 the back adhesive layer and the front adhesive layer are cut around the general outline of the tiles, so that there are no excess ends of adhesive layers around the tiles. On step 715 the location within the general mosaic of each sheet is marked, for example with a sticker placed on any of the adhesive layer, preferably the front adhesive layer. The location is preferably marked in X, Y sheet coordinates. For example, the top left sheet in the overall mosaic is marked as (0,0), the next sheet to the right of the first sheet is marked (1,0) and so on. On step 720 the orientation of each sheet is marked, preferably by placing a sticker or otherwise marking a predetermined part of the sheet, for example the top left area of the sheet. Steps 715 and 720 are especially important for large-scale mosaics comprised of many pages, wherein it may be hard to a human being to decide the order of sheets and the orientation of each sheet within a large mosaic.

On installation steps 750 the mosaic is installed on its final destination. On step 755 the destination location is covered with cement, acrylic, epoxy or any other mosaic glue. On step 760 the back adhesive layer is peeled from the wrapped sheet to be placed. Since the front adhesive layer is preferably more adhesive than the back adhesive layer, and in addition the part of each tile in touch with the front adhesive layer is larger than the part which is in touch with the back adhesive layer, the removal of the back adhesive layer leaves the tiles substantially in full contact with the front adhesive layer. On step 765 the sheet is pressed to the destination location, with the tiles being pressed into the cement. Once the cement mosaic glue is cured and dry so that the front adhesive sheet can be peeled from the tiles without the tiles being pulled from the cement, the front adhesive sheet is removed. On step 770, grout or another filling material is spread between and on the tiles, and later swiped from the faces of the tiles, thus filling the gaps between the tiles.

The disclosed methods and apparatus provide a process for designing, creating and installing mosaics from a given image. The process includes an optional step of marking guidelines on the image, the guidelines indicating features that should be enhanced in the mosaic. Then, the placement of tiles in the mosaic is determined, along the guidelines and in the rest of the images, the colors of the tiles are determined and the mosaic description is optionally divided into sheets, thus enabling the creation of large scale mosaics. The user is offered the option to edit the mosaic description using a variety of graphic options, including adding, deleting, changing the color, moving or rotating one or more tiles, including rotating a group of tiles in a degrading angle. The mosaic layout is preferably presented to a user in a realistic way by displaying scanned images of tiles of the relevant colors, rather than a computer-generated shape for each presented tile. The description is then transferred to a pick and place machine which collects tiles from predetermined locations, each location associated with a predetermined tile color, and carries the tiles to tile locations designated for that color. The tiles are supplies to the machine on strips twisted around reels, in tubes, on trays, or in any other mechanism which delivers each tile to a predetermined location from which it is collected by the machine. The presented methods and apparatus provide a realistic prediction of the mosaic looks in design time, thus enabling adaptation of the mosaic to the user's preferences. The methods and apparatus also support for fast production, thus yielding high throughput of the machinery and reduced manufacturing costs.

A person skilled in the art will appreciate that multiple options and modifications exist to the disclosed methods and apparatus. Various methods for determining tile locations exist, which either use guidelines or not, and may use different methods for resolving intersections. Yet other methods exist for determining or enhancing the colors to be assigned to tiles, for example methods which take into consideration the colors of tiles neighboring the tile to be determined. Yet other options exist for splitting the overall mosaic description into sheets. Placing the tiles according to the determined description can also be performed in multiple ways, and employing multiple types of equipment, whether specifically tailored machines, general pick-and-place machines or machines designated to other purposes which can be used as is or be adapted to the needs of tile placement. It will be appreciated that the disclosed method is not limited to tiles of a single size or shape. Rather, tiles of multiple sizes and multiple shapes, such as rectangles, squares, triangles or free-form tiles can be used for constructing tiles according to the disclosed methods and apparatus.

It will be appreciated by persons skilled in the art that the present invention is not limited to what has been particularly shown and described hereinabove. Rather the scope of the present invention is defined only by the claims which follow.

What is claimed is:

1. An apparatus for generating a mosaic from a computerized file, the mosaic comprising a multiplicity of tiles placed on a surface, the apparatus comprising:
a computing platform executing a process for generating a description of the mosaic from the computerized file; and
a placing machine for placing the multiplicity of tiles on the surface according to the description of the mosaic,
whereby the placement machine takes hold of the tiles, each tile taken from one of a set of predetermined locations and placing each tile in a location on a layer, as designated by the description of the mosaic.

2. The apparatus of claim 1 further comprising a process executed on the first computing platform or on a second computing platform, the process presenting the description of the mosaic and enabling a user to make changes to the description of the mosaic.

3. The apparatus of claim 1 wherein each tile is placed on the location designated by the description of the mosaic by conveying the tile to the location designated by the description of the mosaic on the layer.

4. The apparatus of claim 1 wherein each tile is placed on the location designated by the description of the mosaic by conveying the tile to another predetermined location, and moving the layer horizontally so that the tile is above the location designated by the description.

5. The apparatus of claim 4 wherein the tile is moved vertically towards the layer.

6. The apparatus of claim 4 wherein the layer is moved vertically towards the tile.

7. The apparatus of claim 1 wherein the placement machine is a pick and place machine.

8. The apparatus of claim 1 wherein the placement machine is a surface mounting technology machine.

9. The apparatus of claim 1 wherein the placement machine comprises a vacuum mechanism for picking each of the multiplicity of tiles.

10. The apparatus of claim 1 wherein the multiplicity of tiles are introduced to the placement machine on a strip.

11. The apparatus of claim 10 wherein the strip is twisted around a reel.

12. The apparatus of claim 1 wherein the multiplicity of tiles are introduced to the placement machine in a tube.

13. The apparatus of claim 1 wherein the multiplicity of tiles are introduced to the placement machine on a tray.

14. A method for generating a description of a mosaic from a computerized file, the mosaic comprising a multiplicity of tiles placed on a surface, the method comprising:
generating an initial description of the mosaic, the initial description comprising a location and color indication for each of the multiplicity of tiles; and
graphically editing the initial description of the mosaic.

15. The method of claim 14 wherein the initial description of the mosaic comprises an orientation or a shape for each of the multiplicity of tiles.

16. The method of claim 14 wherein graphically editing the initial description of the mosaic comprises simulating one or more actions from the group consisting of: moving one or more tiles, changing a color of one or more tiles, changing a pattern of one or more tiles, changing a shape of one or more tiles, rotating one or more tiles in a constant angle, rotating one or more tiles in a sequence of angles, removing one or more tiles, and adding one or more tiles.

17. A method for generating a description of a mosaic from a computerized file, the mosaic comprising a multiplicity of tiles placed on a surface, the method comprising:
generating an initial description of the mosaic, the initial description comprising a location and color indication for each of the multiplicity of tiles making up the mosaic; and
presenting to a user a graphic representation of the description of the mosaic on a display device, wherein each tile is presented as a scanned image of a tile.

18. A method for generating a multi-page description of a mosaic From a computerized image, the mosaic comprising a multiplicity of tiles attached to a surface, the method comprising:
generating a description of the mosaic, the initial description comprising a location and color indication for each of the multiplicity of tiles; and
generating a division of the description of the mosaic into a multiplicity of pages along a multiplicity of lines.

19. The method of claim 18 wherein at least one of the multiplicity of lines is a curved line.
